(19) United States
(12) Patent Application Publication
(10) Pub. No.: US 2016/0232469 A1
(43) Pub. Date: Aug. 11, 2016

(54) DEMAND PRIORITY DETERMINATION DEVICE AND METHOD, RECORDING MEDIUM HAVING PROGRAM THEREFOR RECORDED THEREON, AND DEMAND CONTROL DEVICE AND METHOD

(71) Applicant: SAMSUNG SDS CO., LTD., Seoul (KR)

(72) Inventors: Kang Hyoung CHO, Seoul (KR); Dong Ho KIM, Anyang-si Gyeonggi-do (KR); Min Goo KANG, Pyeongtaek-si (KR)

(73) Assignee: SAMSUNG SDS CO., LTD., Seoul (KR)

(21) Appl. No.: 15/023,464

(22) PCT Filed: Sep. 25, 2014
(86) PCT No.: PCT/KR2014/008925

§ 371 Date: Mar. 21, 2016

(30) Foreign Application Priority Data
Sep. 25, 2013 (KR) 10-2013-0113899

(51) Int. Cl. G06Q 10/06; G06Q 30/02

(52) U.S. Cl. CPC G06Q 10/06315; G06Q 30/0204

(57) ABSTRACT

The present invention relates to a demand priority determination device and method, a recording medium having a program therefor recorded thereon, and a demand control device and method, capable of minimizing the impact of a change in the demand of a particular organization on the quantity planned to be supplied to another organization. The demand priority determination device according to one embodiment of the present invention may comprise: a higher-level rank determination unit for determining comprehensive priorities for the confirmed demands of lower-level organizations according to higher-level rules set by higher-level organizations among organizations having the presence of hierarchical relationships between the higher-level organizations and the lower-level organizations; and a lower-level rank determination unit for determining, according to lower-level rules set by any one of the lower-level organizations, priorities for the confirmed demands of some of the lower-level organizations or the one lower-level organization, which has set the lower-level rules.

### BACKGROUND

1. Technical Field

The present inventive concept relates to a demand priority determination device and method, a recording medium having a program therefor recorded thereon, and a demand control device and method. More particularly, the present inventive concept relates to a demand priority determination device and method, a recording medium having a program therefor recorded thereon, and a demand control device and method, capable of minimizing an impact of a change in the demand of a certain organization on the quantity planned to be supplied to another organization.

2. Description of the Related Art

A sales organization of an enterprise generally has a hierarchical structure. Various sales levels of the hierarchical structure may have respective business areas corresponding thereto.

Meanwhile, for the purpose of demand forecast and production management of the enterprise, persons in charge of the respective sales levels may calculate confirmed demands for the levels for which they are respectively responsible and input the calculated confirmed demands in an in-house computer system.

Higher level organizations such as headquarters may determine priority of each of the demands and establish a supply plan on the basis of the input confirmed demands.

However, it is important for higher level organizations such as headquarters to determine priority so as to establish a fair and reliable supply plan among marketing corporations, and it is also important for local organizations to react to short-term changes in demands rather than the fairness among the demands.

A need therefore exists for a technology for determining priority of confirmed demands capable of supporting urgency of local marketing while maintaining fairness of a global supply system.

### SUMMARY

An embodiment of the present inventive concept provides a demand priority determination device and method capable of determining priority of confirmed demands which serve as a basis for an establishment of a supply plan and which can support urgency of local marketing while maintaining supply fairness.

Specifically, an embodiment of the present inventive concept provides a demand priority determination device and method capable of supporting urgency of local marketing while maintaining supply fairness by minimizing an impact of a change in the demand of a certain organization on the quantity planned to be supplied to another organization.

Another embodiment of the present inventive concept provides a demand priority determination device and method which determine priority of confirmed demands of respective lower level organizations according to criteria of a higher level organization, and re-determine the determined priority according to criteria for each of the lower level organizations.

However, embodiments of the present inventive concept are not restricted to those set forth herein. The other embodiments of the present inventive concept which are not mentioned herein will become more apparent to a person skilled in the art to which the present inventive concept pertains by referencing the detailed description of the present inventive concept given below.

According to a first aspect of the present inventive concept, there is provided a demand priority determination device including: a higher level rank determination unit which determines comprehensive priorities of the confirmed demands of lower level organizations according to higher level rules set by higher lever organizations among organizations having the presence of hierarchical relationships between the higher level organizations and the lower level organizations; and a lower level rank determination unit which determines, according to lower level rules set by any one of the lower level organizations, priority of the confirmed demands of a part of the lower level organizations or priority of the confirmed demands of the lower level organization which has set the lower level rules

According to an embodiment, the demand priority determination device may further include a change unit which changes comprehensive priority information determined by the higher level rank determination unit by using the priority information determined by the lower level rank determination unit.

According to a first aspect of the present inventive concept, there is provided a device for determining priority of confirmed demands for each organization, including: a higher level rank determination unit which synthesizes confirmed demands of a first lower level organization and a second lower level organization, and determines comprehensive priorities of the synthesized confirmed demands according to higher level rules set by higher level organizations of the first lower level organization and the second lower level organization; a first lower level rank determination unit which determines priority of the confirmed demands of the first lower level organization by using a first lower level rule when the first lower level rule set by the first lower level organization is present; and a change unit which changes information on the confirmed demand corresponding to each priority of the comprehensive priorities by reflecting the priority of the confirmed demands of the first lower level organization determined by the first lower level rank determination unit to the comprehensive priorities determined by the higher level rank determination unit.

According to an embodiment, the change unit may reflect priority of the confirmed demands of the first lower level organization determined by the first lower level rank determination unit only among priorities of the confirmed demands of the first lower level organization among the comprehensive priorities determined by the higher level rank determination unit.

The change unit may change confirmed demand information corresponding to each of the comprehensive priorities by the priority determined by the first lower level rank determination unit, but may not change priority of the confirmed demand of the second lower level organization among the comprehensive priorities by the priority determined by the first lower level rank determination unit.

According to an embodiment, the higher level organizations may further include a third lower level organization as the lower level organizations, and the first rank determination unit may synthesize confirmed demands of the first lower level organization, the second lower level organization and the third lower level organization, and determine comprehensive priorities of the synthesized confirmed demands according to the higher level rules set by the higher level organizations.

According to an embodiment, the demand priority determination device may further include a second lower level rank determination unit which determines priority of the confirmed demands of the second lower level organization by using a second lower level rule when the second lower level rule set by the second lower level organization and different from the higher level rules is present, and the change unit may change the confirmed demand information corresponding to each priority of the comprehensive priorities by reflecting the priority of the confirmed demands of the second lower level organization determined by the second lower level rank determination unit to the comprehensive priorities determined by the higher level rank determination unit.

The change unit may change the confirmed demand information by reflecting priority of the confirmed demands of the first lower level organization determined by the second lower level rank determination unit only among the priorities of the confirmed demands of the second lower level organization among the comprehensive priorities determined by the higher level rank determination unit, and may change confirmed demand information corresponding to each of the comprehensive priorities by the priority determined by the second lower level rank determination unit, but may not change priority of the confirmed demand of the first lower level organization among the comprehensive priorities by the priority determined by the second lower level rank determination unit.

The confirmed demands of the respective organizations may be segmented into items regarding two or more demand types.

According to a second aspect of the present inventive concept, there is provided a demand control device for determining priority of confirmed demands for each organization, the demand control device including: a higher level rank determination unit which enables a higher level organization of a first lower level organization and a second lower level organization to synthesize confirmed demands of the first lower level organization and the second lower level organization, and determines comprehensive priorities of the synthesized confirmed demands according to higher level rules set by the higher level organization; a first lower level rank determination unit which determines, when a first lower level rule set by the first lower level organization and different from the higher level rules is present, priority of the confirmed demands of the first lower level organization by using the first lower level rule; a change unit which changes a content corresponding to each priority of the comprehensive priorities by reflecting the priority of the confirmed demands of the first lower level organization determined by the first lower level rank determination unit to the comprehensive priorities determined by the higher level rank determination unit; and a demand control unit which distributes a preset planned supply quantity on a basis of the comprehensive priorities of which content is changed by the change unit.

According to an embodiment, the demand control unit may distribute the preset planned supply quantity in a consecutive order from a rank highest in the comprehensive priorities when the preset planned supply quantity is smaller than the total quantity of confirmed demands input by the respective organizations.

The preset planned supply quantity may be distributed in a consecutive order from a rank highest in the comprehensive priorities such that the confirmed demands corresponding to a part of the comprehensive priorities to which the planned supply quantity is not distributed may be processed as a short quantity so as to prevent supply planning therefor.

According to a third aspect of the present inventive concept, there is provided a method for determining priority of confirmed demands for each organization, including: a higher level rank determination step of synthesizing confirmed demands of a first lower level organization and a second lower level organization, and determining comprehensive priorities of the synthesized confirmed demands according to higher level rules set by higher level organizations of the first lower level organization and the second lower level organization; a first lower level rank determination step of determining priority of the confirmed demands of the first lower level organization by using a first lower level rule when the first lower level rule set by the first lower level organization is present; and a changing step of changing information on the confirmed demand corresponding to each priority of the comprehensive priorities by reflecting the priority of the confirmed demands of the first lower level organization determined by the first lower level rank determination step to the comprehensive priorities determined by the higher level rank determination step.

The changing step may reflect priority of the confirmed demands of the first lower level organization determined by the first lower level rank determination step only among the priorities of the confirmed demands of the first lower level organization among the comprehensive priorities determined by the higher level rank determination step.

According to an embodiment, the changing step may change confirmed demand information corresponding to each of the comprehensive priorities by the priority determined by the first lower level rank determination step, but may not change priority of the confirmed demand of the second lower level organization among the comprehensive priorities by the priority determined by the first lower level rank determination step.

The higher level organizations may further include a third lower level organization as the lower level organizations, and the first rank determination step may synthesize confirmed demands of the first lower level organization, the second lower level organization and the third lower level organization, and determine comprehensive priorities of the synthesized confirmed demands according to the higher level rules set by the higher level organizations.

According to an embodiment, the demand priority determination method may further include a second lower level rank determination step of determining priority of the confirmed demands of the second lower level organization by using a second lower level rule when the second lower level rule set by the second lower level organization is present, and the changing step may change the confirmed demand information corresponding to each priority of the comprehensive priorities by reflecting the priority of the confirmed demands of the second lower level organization determined by the second lower level rank determination step to the comprehensive priorities determined by the higher level rank determination step.

The changing step may change the confirmed demand information by reflecting priority of the confirmed demands of the first lower level organization determined by the second lower level rank determination step only among the confirmed demands of the second lower level organization among the comprehensive priorities determined by the higher level rank determination step, and may change confirmed demand information corresponding to each of the comprehensive priorities by the priority determined by the second lower level rank determination step, but may not change priority of the confirmed demand of the first lower level organization among the comprehensive priorities by the priority determined by the second lower level rank determination step.

The confirmed demands of the respective organizations may be segmented into items regarding two or more demand types.

According to a fourth aspect of the present inventive concept, there is provided a demand control method for determining priority of confirmed demands for each organization, including: a higher level rank determination step of enabling a higher level organization of a first lower level organization and a second lower level organization to synthesize confirmed demands of the first lower level organization and the second lower level organization, and determining comprehensive priorities of the synthesized confirmed demands according to higher level rules set by higher level organizations; a first lower level rank determination step of determining priority of the confirmed demands of the first lower level organization by using a first lower level rule when the first lower level rule set by the first lower level organization and different from the higher level rules is present; a changing step of changing a content of the comprehensive priorities corresponding to each priority by reflecting the priority of the confirmed demands of the first lower level organization determined by the first lower level rank determination step to the comprehensive priorities determined by the higher level rank determination step; and a demand control step of distributing a preset planned supply quantity on the basis of the comprehensive priorities of which content is changed by the changing step.

The demand control step may distribute the preset planned supply quantity in a consecutive order from a rank highest in the comprehensive priorities when the preset planned supply quantity is smaller than the total quantity of confirmed demands input by each organization, and process, as a short quantity, the confirmed demands corresponding to a part of the comprehensive priorities to which the planned supply quantity is not distributed so as to prevent supply planning therefor.

According to a fifth aspect of the present inventive concept, there is provided a demand priority determination method which is a computer-readable recording medium having a program recorded thereon, the program performing: a higher level rank determination process of synthesizing confirmed demands of a first lower level organization and a second lower level organization, and determining comprehensive priorities of the synthesized confirmed demands according to higher level rules set by higher level organizations of the first lower level organization and the second lower level organization; a first lower level rank determination process of determining priority of the confirmed demands of the first lower level organization by using a first lower level rule when the first lower level rule set by the first lower level organization is present; and a changing process of changing information on the confirmed demand corresponding to each priority of the comprehensive priorities by reflecting the priority of the confirmed demands of the first lower level organization determined by the first lower level rank determination step to the comprehensive priorities determined by the higher level rank determination step.

As described above, the present inventive concept may determine priority of confirmed demands so as to support urgency of local marketing while maintaining supply fairness.

Furthermore, the present inventive concept may minimize an impact of a change in the demand of a certain organization on the quantity planned to be supplied to another organization, thereby supporting urgency of local marketing while maintaining supply fairness.

Furthermore, the present inventive concept may control demands according to a demand situation, a supply situation, a market situation and the like.

However, effects of the present inventive concept are not restricted to those mentioned above, and other effects that can be obviously inferred through the subject matter set forth in the present description may exist.

### BRIEF DESCRIPTION OF THE DRAWINGS

FIG. 1 illustrates a demand forecasting and supply planning process;

FIG. 2 illustrates an example of an organization hierarchy for determining priority of confirmed demands of an enterprise having a global marketing network;

FIG. 3 illustrates an example of preset items;

FIG. 4 is a flowchart illustrating a priority determination method and a priority-based demand control method according to the present inventive concept;

FIG. 5 is a block diagram illustrating a demand priority determination device according to an embodiment of the present inventive concept;

FIG. 6 illustrates an example which is set to enable preset higher level rules to be applied differently depending on conditions;

FIG. 7 is a block diagram illustrating an embodiment of a higher level rank determination unit;

FIG. 8 illustrates an example in which each item has a rank value determined by an item rank determination unit;

FIG. 9 illustrates an example in which a rank value of a week time item is corrected by a lead time correction unit 130;

FIG. 10 illustrates an example of preset higher level rules;

FIG. 11 illustrates an example of a comprehensive priorities value determined by a comprehensive priorities value determination unit;

FIG. 12 illustrates an example of preset lower level rules;

FIG. 13 illustrates an example of a priority value determined by a lower level rank determination unit;

FIG. 14 illustrates an example in which confirmed demands of each of a German corporation (SEG) and a French corporation (SEF) are synthesized to determine comprehensive priorities by a higher level rank determination unit;

FIG. 15 illustrates an example in which priority of confirmed demands of a first lower level organization is determined by a first lower level rank determination unit of the lower level rank determination unit;

FIG. 16 illustrates an example in which priority of confirmed demands of a second lower level organization is determined by the first lower level rank determination unit of the lower level rank determination unit;

FIG. 17 illustrates an example in which priority of confirmed demands of each lower level organization determined by the first lower level rank determination unit and the second lower level rank determination unit as shown in FIG. 15 and FIG. 16 is reflected to the comprehensive priorities by a change unit;

FIG. 18 illustrates an example in which priority is determined by the higher level rank determination unit according to preset higher level rules;

FIG. 19 illustrates an example of a priority value and priority of confirmed demands of the French corporation determined by the lower level rank determination unit;

FIG. 20 illustrates an example of a result of reflecting the content of FIG. 19 to FIG. 18 by a change unit;

FIG. 21 is a block diagram of a demand control device according to an embodiment of the present inventive concept;

FIG. 22 illustrates an example of a result of entering a confirmed demand request quantity (Req. Qty) in order of the priority determined by the demand priority determination device according to an embodiment of the present inventive concept;

FIG. 23 illustrates an example in which a deficient quantity is processed as a short quantity (Shrt. Qty) by a demand control unit under the situation of FIG. 22;

FIG. 24 illustrates a configuration of the demand priority determination device according to an embodiment of the present inventive concept;

FIG. 25 is a flowchart of a demand priority determination method according to a preferred embodiment of the present inventive concept; and

FIG. 26 is a flowchart of a demand control method according to an embodiment of the present inventive concept.

### DETAILED DESCRIPTION OF THE EMBODIMENTS

Preferred embodiments of the present inventive concept will now be described with reference to the attached drawings. Advantages and features of the present inventive concept, and methods for accomplishing the same will become apparent by referring to embodiments described in detail later with reference to the drawings. The present inventive concept may, however, be embodied in different forms and should not be construed as limited to the embodiments set forth herein. Rather, these embodiments are provided so that this disclosure will be thorough and complete, and will fully convey the scope of the present inventive concept to those skilled in the art to which the present inventive concept belongs, and the present inventive concept will be defined only by the scope of the claims. The same reference numbers indicate the same components throughout the specification.

It will be understood that when an element is referred to as being “connected to,” or “coupled to” another element, it can be directly connected to or coupled to another element or intervening elements may be present. In contrast, it will be understood that when an element is referred to as being “directly connected to” or “directly coupled to” another element, there are no intervening elements present.

Unless defined otherwise, all terms (including technical and scientific terms) used herein have the same meaning as commonly understood by one of ordinary skill in the art to which the present inventive concept belongs. Further, unless defined otherwise, all terms defined in generally used dictionaries may not be interpreted in an idealized or overly sense.

As used herein, singular forms are intended to include plural forms as well, unless otherwise noted. It will be understood that the terms “comprises” and/or “comprising,” when used in this specification, specify the presence of the stated components, steps, operations, and/or elements, but do not preclude the presence or addition of one or more other components, steps, operations, and/or elements.

A demand forecasting and supply planning process of an enterprise will now be described with reference to FIG. 1. First, a sale organization may forecast marketing volumes for a predetermined future period (planning period) after the present agreed with a production organization, and input the values of the forecasted sales volumes to an associated system on a daily, weekly or monthly basis (S1). The input values are used in confirming consensus-based demands after a consultation of participants in demand forecasting (S2). The confirmed demands are segmented and classified according to components of the confirmed demand based on order information for orders requesting a delivery to be performed during the planning period and existing confirmed supply planning information (S3). Priority of each of the classified confirmed demands is determined according to the pre-calculated profitability of products and significance of customers (S4). For each confirmed demand having determined priority, availability of materials required for production of the products and equipment required for assembling or fabrication of the products is checked, and a supply plan for the planning period is established (S5). The feasibility of the established supply plan is finally checked and adjusted by a production department, and then the supply plan is notified to a sales department (S6).

According to an embodiment, the present inventive concept can be used in the priority determination step (S4) of determining priority of each of the classified items by using the confirmed demand information segmented and classified according to components of demand in the demand forecasting and supply planning process shown in FIG. 1. However, the present inventive concept can also be used in other fields for applying effects of the present inventive concept as well as in the step (S3) of determining priority of confirmed demands.

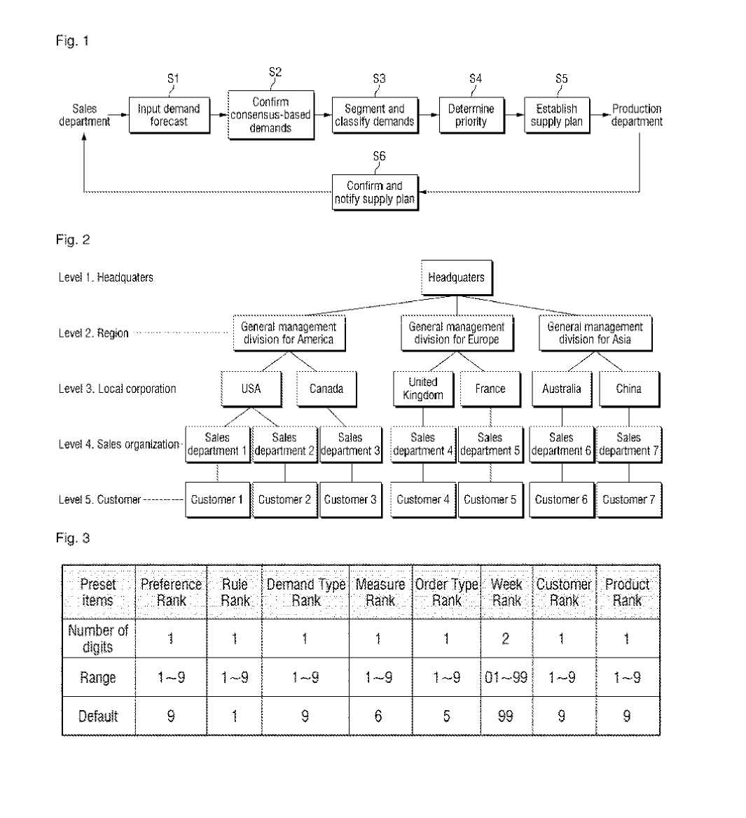

FIG. 2 illustrates an example of an organization hierarchy for determining priority of confirmed demands of an enterprise having a global marketing network.

Enterprises may have different structures and levels of organizations that determine priority. FIG. 2 illustrates an example of a priority determination organization including levels of headquarters, regions, local corporations, sales organizations, and customers.

Confirmed demand information may be input from one or more lower level organizations, and priority of confirmed demands is determined by using the input confirmed demand information, and an organization that determines priority may have one or more lower level organizations. For example, an organization that determines priority may be headquarters, headquarters of level 1, each region of level 2, and each local corporation of level 3 in FIG. 2.

The organization used to describe the present inventive concept can be an enterprise, an organization, a corporation and the like in each level. That is, in FIG. 2, the organization can be each of headquarters, a general management division for America, a general management division for Europe, a general management division for Asia, an American corporation, a Canadian corporation, a British corporation, a French corporation, an Australian corporation, a Chinese corporation, and sales departments 1 to 7.

Each of these organizations may determine priority of confirmed demands by using the demand priority determination device and method of the present inventive concept.

Furthermore, priority information of confirmed demands determined by a certain organization can be input to a higher level organization. The higher level organization reflects priority of each of lower level organizations input by the lower level organizations so as to determine priority of confirmed demands by using the demand priority determination device and method of the present inventive concept.

Alternatively, a headquarter level, a region level, or a local corporation level may take, as an input, confirmed demand information from lower level organizations, and determine priority of confirmed demands of the lower level organizations.

The confirmed demand information may be those regarding demands input from lower level organizations of each level, and may include information on preset items.

The preset items may be used in determining priority, and can be set as shown in FIG. 3 for example.

FIG. 3 illustrates an example of preset items.

Referring to FIG. 3, the preset items may include an item on the significance of customers (Preference Rank), an item on demand types (Demand Type Rank), an item on information input entities (Measure Rank), an item on order attributes (Order Type Rank), an item on a demand request time (Week Rank), an item on customers based on profit and loss record criteria (Customer Rank), and/or an item on products based on profit and loss record criteria (Product Rank).

However, the preset items are not limited to those illustrated as an example in FIG. 3, and may change for various reasons such as a situation of an enterprise, a type of an article, a type of an enterprise organization, and a market situation.

Furthermore, although the item on a demand request time is denominated as Week Rank for ease of division and understanding, this denomination does not necessarily mean that the demand request time is set on a weekly basis. That is, the demand request time can be set on various time bases such as a daily, monthly, and hourly basis.

Determining priority of confirmed demands may mean that priority of confirmed demands of each of a plurality of lower level organizations is determined in a consecutive order from the top priority confirmed demand by using information contained in each confirmed demand. Determining priority of confirmed demands may be needed for a profit and future of an enterprise when a supply that satisfies all of confirmed demands required by lower level organizations does not exist, when establishing criteria for controlling demands or supplies in a strategic level of an enterprise, when considering profitability, and so on.

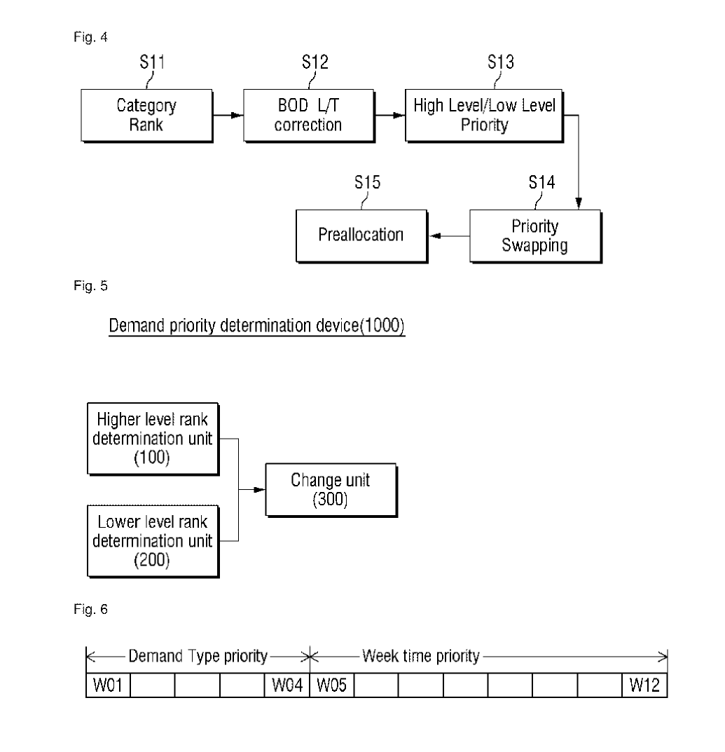

FIG. 4 is a flowchart illustrating a method for determining priority of confirmed demands and controlling demands by using a demand priority determination method according to the present inventive concept.

A method for determining priority of confirmed demands by using a priority determination method according to the present inventive concept will be described with reference to FIG. 4.

Referring to FIG. 4, a category rank step (S11) may determine a rank value of each item by using information on each preset item contained in the confirmed demand information input from each of the lower level organizations.

A bill of distribution (BOD) lead time (L/T) correction step (S12) may correct a rank value of the item on a demand request time (Week Rank) among category ranks in consideration of lead time of BOD.

A high level/low level priority step (S13) may arrange values of each category rank on the basis of higher level rules which are priority policies set in a company-wide level so as to determine a unified comprehensive priorities value. Meanwhile, when a priority policy for each region is set, category ranks are re-arranged on the basis of lower level rules set for each organization or marketing region so as to determine another comprehensive priorities value.

The high level/low level priority step (S13) may determine a comprehensive priorities value by using rank values of each item to which information on the rank value corrected by the BOD L/T correction step (S12) is reflected.

A priority swapping step (S14) may arrange demands in order of priority on the basis of the comprehensive priorities value determined according to lower level rules, and reflect the arranged order to the priority determined on the basis of the comprehensive priorities value determined according to higher level rules.

The priority of the confirmed demands can be determined by using steps S11 to S14 of FIG. 4, and the order of steps S11 to S14 can be changed, or a certain step can be omitted as needed.

Still referring to FIG. 4, a preallocation step (S15) of the demand control method of the present inventive concept may limit a demand quantity or process a confirmed demand quantity exceeding the limited demand quantity as a short quantity on the basis of the priority of confirmed demands determined by the demand priority determination method of the present inventive concept.

The demand priority determination method described with reference to FIG. 4 is merely an example of methods for determining priority of confirmed demands.

The demand priority determination device and method of the present inventive concept may have advantages of determining priority of confirmed demands in such a manner as to satisfy urgency of local marketing while maintaining material supply fairness in consideration of a requisite or a major consideration of the criteria for determining priority of two or more confirmed demands when there exist two or more criteria for determining priority of confirmed demands, for example, higher level rules and lower level rules.

That is, the demand priority determination device and method of the present inventive concept may not be limitedly applied to the example of determining priority of confirmed demands described with reference to FIG. 4, but can be applied to all cases when there exist two or more criteria for determining priority of confirmed demands.

FIG. 5 is a block diagram illustrating a demand priority determination device according to an embodiment of the present inventive concept.

Referring to FIG. 5, a demand priority determination device 1000 according to an embodiment of the present inventive concept may include a higher level rank determination unit 100, a lower level rank determination unit 200, and a change unit 300.

The higher level rank determination unit 100 will now be described in detail.

The higher level rank determination unit 100 may synthesize confirmed demands of lower level organizations, and determine comprehensive priorities of the synthesized confirmed demands according to higher level rules set by higher level organizations.

The higher level rules may mean methods set by higher level organizations in regard to methods for determining priority of confirmed demands on the basis of demand information input from lower level organizations. In this case, the higher level organizations may be organizations of higher levels from the lower level organizations, and may be immediate higher level organizations from certain lower level organizations or few rungs above certain lower level organizations.

Referring to FIG. 2, when lower level organizations include the American corporation and the Canadian corporation for example, higher level organizations may be the general management division for America or headquarters.

Furthermore, higher level rules may be set to be applied differently depending on conditions.

Specifically, an example in which higher level rules are set to be applied differently depending on conditions will be described with reference to FIG. 6.

Referring to FIG. 6, when a value of a Week Rank item is 01 to 04, higher level rules are set to enable comprehensive priorities to be determined by putting higher priority on Demand Type, and when a value of a Week Rank item is 05 to 12, higher level rules are set to enable comprehensive priorities to be determined by putting higher priority on a Week Time item.

Lower level rules may also be set to be applied differently depending on conditions.

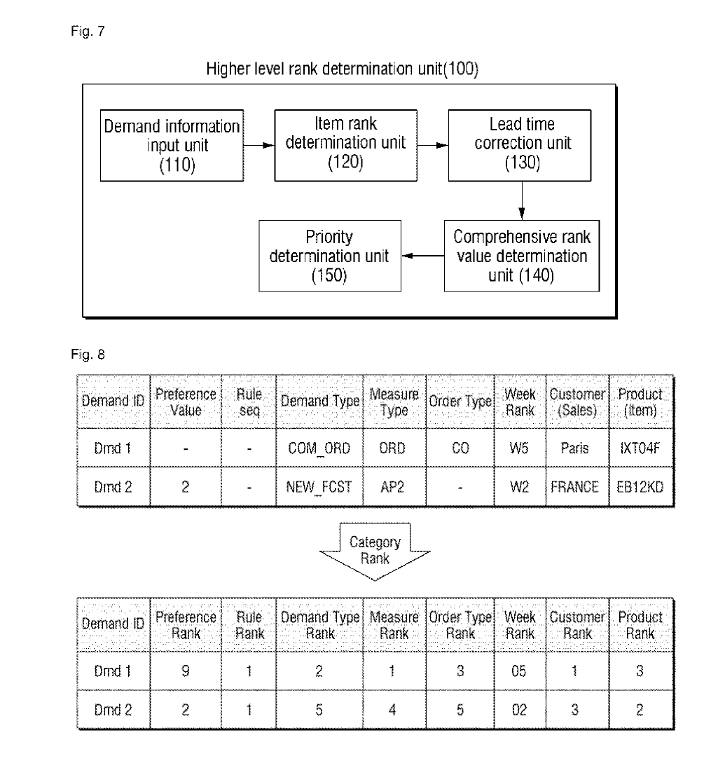

A method in which the higher level rank determination unit 100 synthesizes confirmed demands of lower level organizations, and determines comprehensive priorities of the synthesized confirmed demands according to higher level rules set by higher level organizations will be described in detail with reference to FIG. 7 to FIG. 9.

However, the method described in connection with the higher level rank determination unit 100 with reference to FIG. 7 to FIG. 9 is merely an example of methods by which the higher level rank determination unit 100 determines comprehensive priorities according to higher level rules, and the present disclosure is not limited thereto.

FIG. 7 is a block diagram illustrating an embodiment of a higher level rank determination unit.

Referring to FIG. 7, the higher level rank determination unit 100 may include a demand information input unit 110, an item rank determination unit 120, a lead time correction unit 130, a comprehensive rank value determination unit 140, and a comprehensive priorities determination unit 150.

The demand information input unit 110 may take, as an input, pieces of confirmed demand information of each of lower level organizations, including information on preset items, and synthesize the input pieces of confirmed demand information. Synthesizing the pieces of confirmed demand information of each of lower level organizations may include gathering and integrating information. That is, the higher level rank determination unit may synthesize confirmed demands of each of lower level organizations and determine priority rather than determining priority of confirmed demands of each of lower level organizations separately from each other.

For example, when a first lower level organization has confirmed demands a and b, and a second lower level organization has confirmed demands c, d and e, the demand information input unit 110 may synthesize confirmed demands a, b, c, d and e of each of lower level organizations, and the comprehensive priorities determination unit 150 may finally determine priority of a, b, c, d and e from a first rank to a fifth rank. That is, taking, as an input, pieces of confirmed demand information of each of lower level organizations, and synthesizing the input pieces of confirmed demand information means that a, b, c, d and e are synthesized and prioritized from the first rank to the fifth rank rather than determining the first rank and the second rank among a and b and determining the first rank, the second rank and the third rank among c, d and e.

The preset items included in the confirmed demand information may be the same as those described above with reference to FIG. 3, and may change for various reasons such as a situation of an enterprise, a type of an article, a type of an enterprise organization, and a market situation.

The information on the preset items taken, as an input, by the demand information input unit 110 may include detailed item information set for each item in a company-wide level of an enterprise. For example, an item regarding a demand type among the preset items may include detailed selection information such as a quantity preemptively planned to supply with respect to a quantity of committed order (COM_ORD), a quantity preemptively promised to supply with respect to a quantity of net demand forecast obtained by subtracting the quantity of committed order (COM_FCST), a quantity of new order exceeding the quantity preemptively promised to supply (NEW_ORD), a quantity of net demand forecast exceeding the quantity preemptively promised to supply (NEW_FCST), and a quantity of order exceeding a quantity of demand forecast (UNF_ORD). By way of another example, an item regarding order attributes among the preset items may include detailed selection information such as shipment (GI), delivery instructed (DO), period of delivery promised (CO), and order received only (NO).

That is, the information taken, as an input, by the demand information input unit 110 may include selected detailed information for each preset item. If there exists no selected detail information in the information taken, as an input, by the demand information input unit 110, the input information can be processed as Default.

The item rank determination unit 120 may determine rank values of the respective preset items by using the confirmed demand information taken, as an input, by the demand information input unit 110.

The rank value indicated by each of the detailed selection information existing in the respective preset items may be preset, and the item rank determination unit 120 may determine a rank value corresponding to the selected detailed information on the basis of the preset rank value.

For example, the item rank determination unit 120 may determine a rank value in two-digit numbers with regard to an item on a demand request time (Week Rank), and determine a rank value in one-digit number with regard to items other than the item on a demand request time among the preset items.

Specifically, referring to FIG. 3, the item rank determination unit 120 may determine a rank value of numerals 1 to 9 on the basis of detailed selection information with regard to an item on the significance of customers. Similarly, the item rank determination unit 120 may determine a rank value of numerals 1 to 9 on the basis of each of detailed selection information with regard to an item on a demand type (Demand Type Rank), an item on information input entities (Measure Rank), an item on order attributes (Order Type Rank), an item on customers based on profit and loss record criteria (Customer Rank), and an item on products based on profit and loss record criteria (Product Rank).

The item rank determination unit 120 may determine a rank value of numerals 01 to 99 on the basis of detailed selection information with regard to an item on a demand request time (Week Rank). Since the demand request time may be 10 weeks or more, the item rank determination unit 120 may determine a rank value expressed in two-digit numbers among 1 to 9 as 01 to 09 for consistency of expression. The item rank determination unit 120 will be described by way of example with reference to FIG. 8.

FIG. 8 illustrates an example in which each item has a rank value determined by the item rank determination unit.

For example, the item rank determination unit 120 may determine a rank value for each item by using the information taken, as an input, by the demand information input unit 110, which will be described with reference to FIG. 8, and demand ID in the upper table of FIG. 8 is an identifier for identifying a confirmed demand. Different demand IDs may mean that organizations which have inputted confirmed demand information are different from each other, and even when the organizations which have inputted confirmed demand information are the same, different demand IDs may indicate confirmed demand information which has been separately input due to a difference in a demand request time and the like.

Rule Seq may indicate information regarding nth rule to accord when preset higher level rules use different rules on the condition of a value of a certain item. That is, the Rule Rank item may contain information on the rule being used in cases where different rules are used depending on conditions or periods as described with reference to FIG. 6 when a comprehensive priorities value is determined by the comprehensive rank value determination unit 140, which will be described in detail later. This item may not exist when rules used in determining a comprehensive priorities value in the respective periods are not different.

The upper table of FIG. 8 shows detailed information of each item input by the demand information input unit 110, and the lower table of FIG. 8 shows an example in which rank values corresponding to detailed information of each item are determined by the item rank determination unit 120.

Still referring to FIG. 8, it is noted that each item includes detailed information. That is, it is noted that information on the Demand Type item of Dmd 1 confirmed demand is COM_ORD, and information on the Demand Type item of Dmd 2 confirmed demand is NEW_FCST. The item rank determination unit 120 may determine rank value 2 corresponding to COM_ORD of Demand Type item as a rank value of the Demand Type item of Dmd1 on the basis of preset rank value. Furthermore, the item rank determination unit 120 may determine rank value 5 corresponding to NEW_FCST of Demand Type item as a rank value of the Demand Type item of Dmd1 on the basis of preset rank value.

By way of another example which will be described with reference to FIG. 8, the item rank determination unit 120 may determine rank values of the Week Rank item for every confirmed demand by using information W5 and W2 on the Week Rank item of Dmd 1 and Dmd 2. Referring to the lower table of FIG. 8, the rank value of the Week Rank item of Dmd 1 determined by the item rank determination unit 120 is 05, and the rank value of the Week Rank item of Dmd 2 determined by the item rank determination unit 120 is 02.

The item rank determination unit 120 may determine a rank value for each item of each confirmed demand on the basis of preset rank value. The rank values indicated by the detailed selection information can be preset as described above. However, such presets can be changed by various conditions such as a situation of an enterprise, a market situation, and a type of an article. For example, in FIG. 8, although detailed information COM_ORD selected in the Demand Type item is preset as information indicating rank value 2, detailed information COM_ORD can be set as information indicating another rank value such as rank value 3 in another enterprise or in another situation in the same enterprise.

When selected information of a certain item does not exist in the information of each confirmed demand, the item rank determination unit 120 may process the information as Default so as to determine the rank value indicated by Default as a rank value of the corresponding item. The rank value indicated by Default can be preset for each item. Referring to FIG. 8, since preference value information which corresponds to the Preference Rank item of confirmed demand Dmd1 does not exist, the corresponding item may be processed as Default and rank value 9 indicated by Default of the Preference Rank item can be determined as a rank value of the Preference Rank item of Dmd 1.

An example of rank values indicated by Default in each item may be as shown in FIG. 3, and the rank values can be changed for various reasons such as a market situation and business environment.

The lead time correction unit 130 may correct the item on a demand request time (Week Rank) relating to a lead time among rank values of respective items determined by the item rank determination unit 120 by using BOD lead time information.

BOD may mean a table in which a product transport path, a transporting means, a travel time and the like are set when planning interregional movement of products, that is, product transport. That is, the lead time correction unit 130 may reflect BOD lead time from a production area to a corporation distribution center (DC) or a destination so as to correct the item (Week Rank).

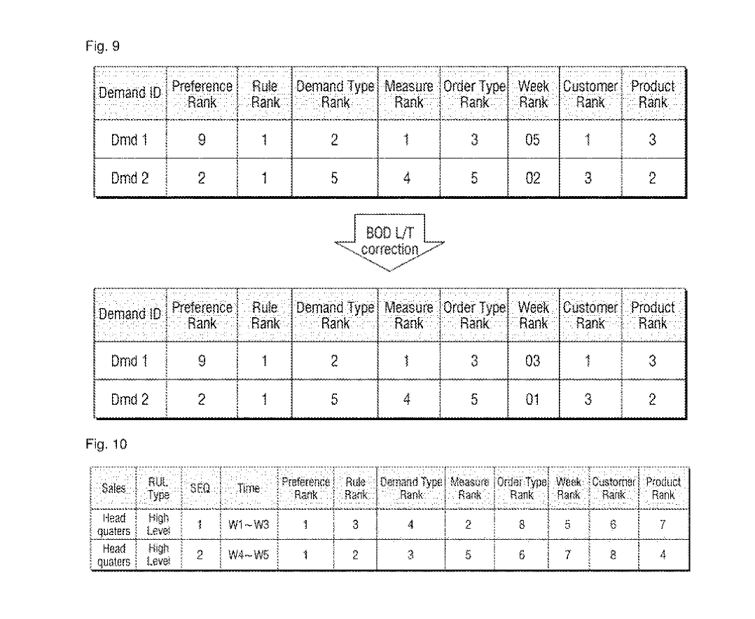

An example in which the rank value of the week time item is corrected by the lead time correction unit 130 will be described with reference to FIG. 9.

FIG. 9 illustrates an example in which a rank value of a week time item is corrected by the lead time correction unit 130.

Referring to FIG. 9, the upper table shows rank values of respective items of different confirmed demands determined by the item rank determination unit 120. Referring to the upper table of FIG. 9, the rank value of the Week Rank item of confirmed demand Dmd1 is 05, and the rank value of the Week Rank item of confirmed demand Dmd2 is 02.

It is assumed that the lead time of moving demand request product IXT04F (the product corresponding to product rank 3, see FIG. 8) of confirmed demand Dm1 from a production area to a Paris organization which is a destination (the destination corresponding to customer rank 1, see FIG. 8) is 2 weeks, and the lead time of moving demand request product EB12KD (the product corresponding to product rank 2, see FIG. 8) of confirmed demand Dm2 from a production area to a France organization which is a destination (the destination corresponding to customer rank 1, see FIG. 8) is 1 week.

In this case, referring to the lower table of FIG. 9, it is considered that the lead time correction unit 130 has corrected the rank values by reflecting the lead time of each confirmed demand, that is to say, the lead time correction unit 130 has corrected the rank value of Week Rank item of Dmd 1 to 03 obtained by subtracting 2 weeks from 05, and the rank value of Week Rank item of Dmd 2 to 01 obtained by subtracting 1 week from 02.

If the lead time correction unit 130 does not correct rank values by reflecting the lead time, a certain organization having a relatively longer BOD lead time may be at a disadvantage compared to another organization having a relatively shorter BOD lead time, and thus may have problems in production planning and supply planning.

The comprehensive rank value determination unit 140 may arrange rank values of respective items determined by the item rank determination unit 120 according to preset higher level rules so as to determine a comprehensive priorities value. Preferably, the comprehensive rank value determination unit 140 may arrange determined rank values of respective preset items corrected by the lead time correction unit 130 according to preset higher level rules so as to determine a comprehensive priorities value.

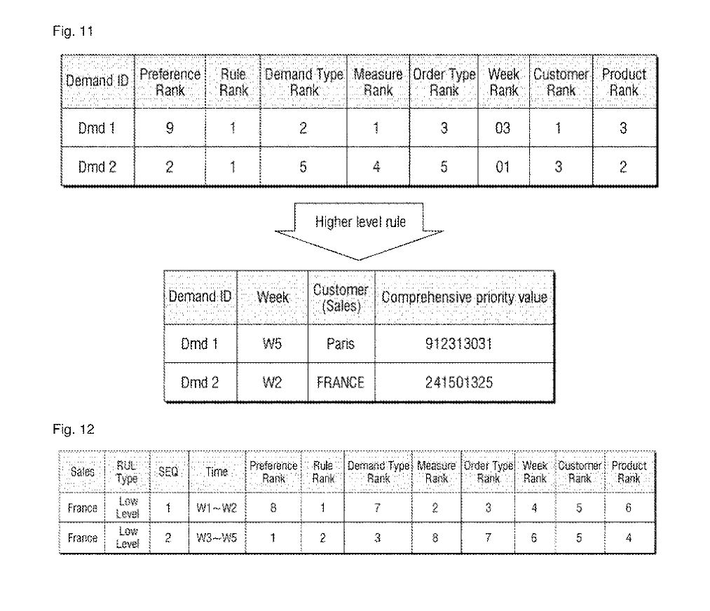

An embodiment of the comprehensive rank value determination unit 140 will be described in detail with reference to FIG. 10 and FIG. 11.

FIG. 10 illustrates an example of preset higher level rules.

Referring to FIG. 10, a rule type item indicates information on the type of an applied rule. The rule type shown in FIG. 10 is a higher level rule. SEQ indicates an identification number of a rule identified according to conditions when preset higher level rules are different depending on the conditions. A time item indicates a condition for determining a preset higher level rule to be finally applied. That is, SEQ can be determined by the condition. The condition may change.

Thus, referring to FIG. 10, the rule type being a high level, SEQ beings 1, and time being W1 to W3 may mean that a comprehensive priorities value is determined by applying number 1 among higher level rules when the selected detailed information of the Week Rank item is 01 to 03.

Referring to FIG. 10, numerals of the respective items from preference rank to product rank may mean the order of arrangement of rank values of the respective items determined by the item rank determination unit 120 (or rank values to which rank values corrected by the lead time correction unit 130 are applied).

FIG. 11 illustrates an example of a comprehensive priorities value determined by the comprehensive rank value determination unit.

An example of the comprehensive priorities value determined by the comprehensive rank value determination unit 140 will be described with reference to FIG. 10 and FIG. 11.

The upper table of FIG. 11 shows determined rank values of respective items of confirmed demands Dmd 1 and Dmd 2 different from each other. Rank values 03 and 01 of Week Rank item among the determined rank values may be corrected respectively by the lead correction unit.

The value of the week item in the lower table of FIG. 11 may be information which determines conditions of preset rules applied differently in each period.

W5 and W2 are respectively detailed information indicated by the rank values of the Week Rank item before being corrected by the lead correction unit. This will be more clearly understood with reference to FIG. 8 and FIG. 9.

The comprehensive priorities value of confirmed demand Dmd 1 will be explained first. Week information of Dmd 1 is W5, and when the comprehensive priorities value is determined by applying higher level rules, the comprehensive rank value determination unit 140 may arrange rank values of the respective items according to the rule in which SEQ is 2 among the higher level rules of FIG. 10 so as to determine a comprehensive priorities value of Dmd 1.

Specifically, referring to FIG. 11, preference rank is a first rank, rule rank is a second rank, demand type rank is a third rank, product rank is a fourth rank, measure rank is a fifth rank, order type rank is a sixth rank, Week Rank is a seventh rank, and customer rank is an eighth rank. According to these ranks, the rank values of the respective items of Dmd 1 in FIG. 11 can be arranged in 9 1 2 3 1 3 03 1.

That is, the comprehensive rank value determination unit 140 may arrange the rank values of the respective items of confirmed demand Dmd 1 according to the second rule among higher level rules so as to determine a comprehensive priorities value as 912313031.

Similarly, the comprehensive rank value determination unit 140 may determine a comprehensive priorities value of Dmd 2 as 241501325 by applying a first (SEQ 1) rule among higher level rules under the condition of W2 when determining the comprehensive priorities value of Dmd 2 according to higher level rules.

The comprehensive priorities value determined by the comprehensive rank value determination unit 140 may vary depending on changes in setup of the rank value indicated by Default, setup of the rank value indicated by detailed information of each item, and the like. Furthermore, the comprehensive priorities value is not necessarily in a number format, but can be described in various alphabets.

The comprehensive priorities determination unit 150 of the higher level rank determination unit 100 may determine comprehensive priorities of each of confirmed demands by using the comprehensive priorities value of confirmed demands determined by using preset higher level rules. For example, the comprehensive priorities determination unit 150 may determine a comprehensive priorities value such that priority becomes higher as the size of the comprehensive priorities value becomes smaller.

Alternatively, the comprehensive priorities determination unit 150 may determine priority of confirmed demands by applying the comprehensive priorities value of each of confirmed demands to a preset functional formula.

The lower level rank determination unit 200 may determine priority for confirmed demands by using lower level rules when lower level organizations have respective preset lower level rules.

The lower level rules may mean methods set by lower level organizations with regard to methods for determining priority of confirmed demands in a manner different from that of higher level rules. The lower level rules set by lower level organizations exist in addition to the higher level rules set by higher level organizations so as to consider various situations of the respective regions such as characteristics of marketing regions, market situation, short-term changes in demands, urgency of local marketing of lower level organizations.

Each lower level organization may not necessarily have a lower level rule suitable for characteristics of each organization, but only a part of lower level organizations may have lower level rules different from higher level rules. Furthermore, the lower level rule set by a certain lower level organization can be used in another lower level organization. Furthermore, the lower level organization can be a higher level organization of further lower level organizations.

The lower level rank determination unit 200 may determine priority among confirmed demands of lower level organizations in a manner similar to that of the priority determination unit of the higher level rank determination unit 100.

However, unlike the higher level rank determination unit 100, the lower level rank determination unit 200 may determine only priority among confirmed demands of lower level organizations to which the preset lower level rules are applied by using preset lower level rules.

An example of a method in which the lower level rank determination unit 200 determines ranks by using a method similar to that of the higher level rank determination unit 100 or preset lower level rules will be described with reference to FIG. 12 and FIG. 13.

FIG. 12 illustrates an example of preset lower level rules.

FIG. 13 illustrates an example of a priority value determined by the lower level rank determination unit.

FIG. 12 is similar to FIG. 10, but illustrates an example in which lower level rules rather than higher level rules are set, and a priority value can be determined in FIG. 13 like the example illustrated in FIG. 13, and priority among confirmed demands of a lower level organization to which a lower level rule is applied can be determined by using the determined priority value.

Specifically, when a first lower level organization is Paris, a first lower level rank determination unit may determine a priority value of Dmd 1 according to a lower level rule of Paris. However, a lower level rule set by a Paris corporation does not exist, and the priority value of Dmd 1 can be determined according to the lower level rule set by a French corporation which is a higher level organization than the Paris corporation and a lower level organization than headquarters.

However, when a lower level rule set by the Paris corporation exists, the priority value of Dmd 1 can be determined according to the set rule, and a comprehensive priorities value may change in this case. Referring to FIG. 12, it is assumed that the Paris corporation determines priority among confirmed demands of the Paris corporation by using the lower level rule set by the French corporation.

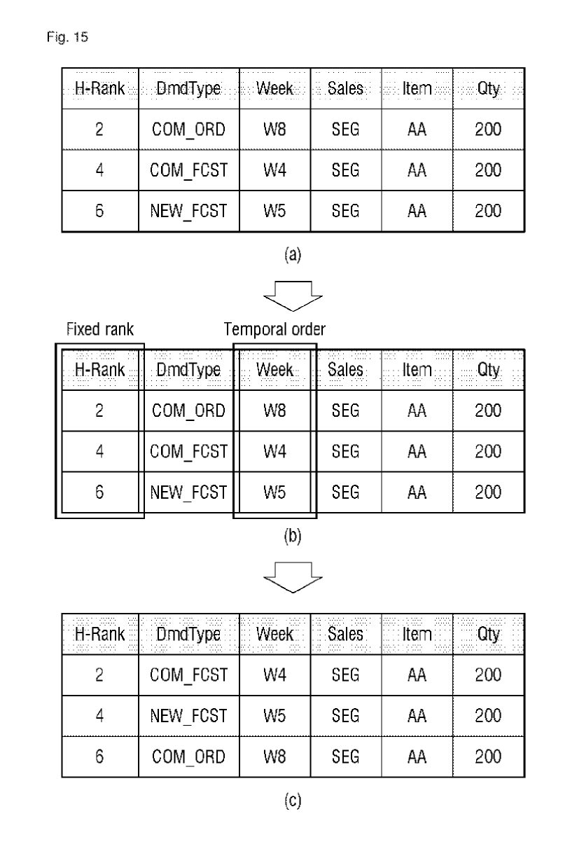

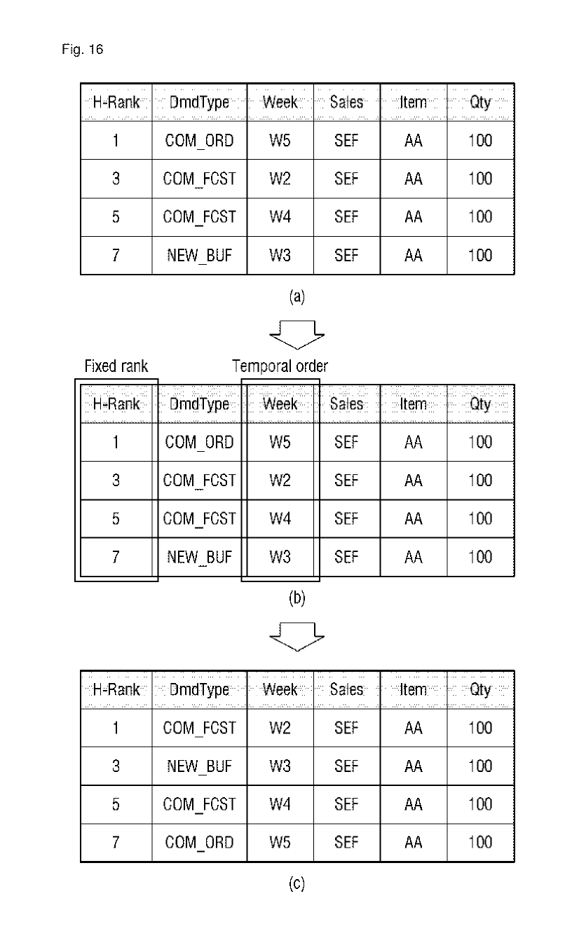

Since the condition is W5, a second lower level rule among the lower level rules of France can be applied. That is, when rank values of respective items of FIG. 15 are arranged according to the arrangement order of the items indicated in the last row in FIG. 15, the first lower level rank determination unit of the lower level rank determination unit 200 may determine the priority value of Dmd 1 as 912310331.

If a second lower level organization is France, a second lower level rank determination unit of the lower level rank determination unit 200 may determine as 145013252 by applying a first (SEQ 1) rule among the lower level rules of France under the condition of W2.

The change unit will be described by referring back to FIG. 5.

The change unit 300 may reflect priority among confirmed demands of the first lower level organization determined by the first lower level rank determination unit to the comprehensive priorities determined by the higher level rank determination unit 100 so as to change information of confirmed demands corresponding to the respective priorities of the comprehensive priorities.

Specifically, a process of finally confirming priority of confirmed demands by the change unit 300 will be described under the assumption that the first lower level organization and the second lower level organization exist as lower level organizations of a higher level organization which has set a higher level rule, the first lower level organization has set a first lower level rule, and the second lower level organization has set a second lower level rule.

In this case, the first lower level rank determination unit of the lower level rank determination unit 200 may determine priority of confirmed demands of the first lower level organization by using the preset first lower level rule, and similarly, the second lower level rank determination unit of the lower level rank determination unit 200 may determine priority of confirmed demands of the second lower level organization by using the preset second lower level rule.

This assumption is merely to help understand the present inventive concept, and the present disclosure is not limited thereto. That is, the lower level organization may be a plurality of organizations including a third lower level organization, a fourth lower level organization and the like, and the whole or a part of the plurality of lower level organizations may have respective lower level rules set therein. The lower level rules set by the respective lower level organizations may be different from each other or the same.

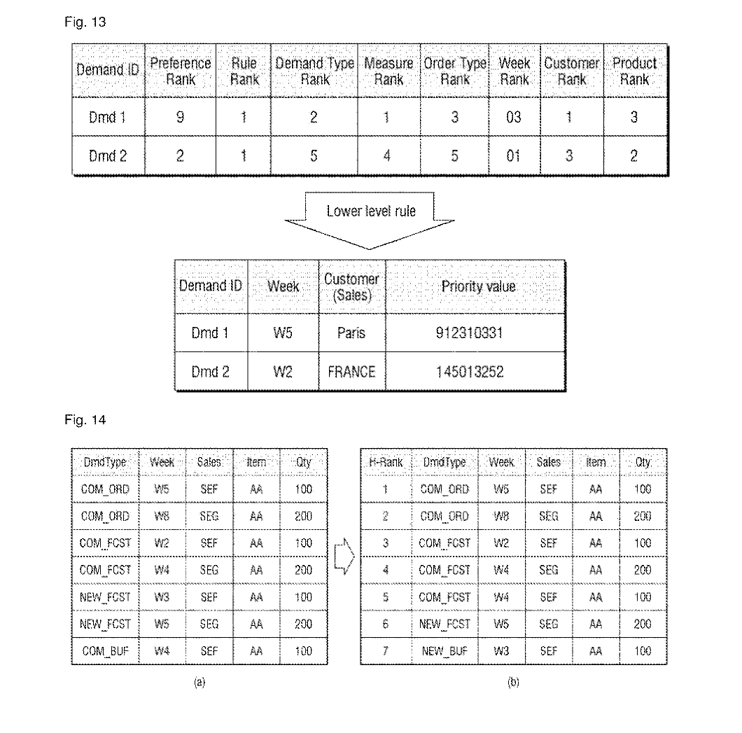

Specifically, an example in which information of confirmed demands corresponding to the respective priorities of a comprehensive priorities changes by the change unit 300 will be described with reference to FIG. 14 to FIG. 17.

FIG. 14 illustrates an example in which confirmed demands of each of a German corporation (SEG) and a French corporation (SEF) are synthesized to determine comprehensive priorities by the higher level rank determination unit 100.

FIG. 14 (a) illustrates confirmed demand information obtained by synthesizing confirmed demands of the German corporation (SEG) and confirmed demands of the French corporation (SEF). The higher level rank determination unit 100 may determine priority of confirmed demand information obtained by synthesizing confirmed demands according to preset higher level rules.

FIG. 14 (b) illustrates the result of determination of comprehensive priorities from a first rank to a seventh rank performed by the higher level rank determination unit 100 according to preset higher level rules.

The preset higher level rules used in determining priority in FIG. 14 (b) may be an order of items regarding a demand type (DmdType), and ranks for detailed contents of the item regarding a demand type can be determined according to significance in advance as described with reference to FIG. 3.

FIG. 15 illustrates an example in which priority of confirmed demands of the first lower level organization is determined by the first lower level rank determination unit of the lower level rank determination unit 200.

Referring to FIG. 15, the first lower level rank determination unit of the lower level rank determination unit 200 may determine priority of confirmed demands of the German corporation (SEG) which is the first lower level organization on the basis of the first lower level rule set by the German corporation (SEG). Referring to FIG. 15, the first lower level rule can be set to determine priority of confirmed demands by putting top priority on the week item among the items contained in the confirmed demands. The week item is an item regarding time, and thus can be an item regarding a demand request time (Week Rank) in FIG. 3. That is, the week item can be an item regarding urgency of local marketing, and putting priority to the week item can be a reflection of urgency of local marketing.

Specifically, referring to FIG. 15 (a), the first lower level rule may be applied only among confirmed demands of the first lower level organization. More specifically, the first lower level rule may be applied only among confirmed demands of the lower level organization which is set to enable the first lower level rule to be applied thereto. Referring to FIGS. 15 (b) and (c), priority of confirmed demands of the German corporation (SEG) which is the first lower level organization is changed according to the first lower level rule based on week item. That is, the lower level rank determination unit 200 may determine priority of confirmed demands of the German corporation (SEG) by using the first lower level rule such that priority becomes higher as the numerical value of week item becomes smaller.

Similarly, referring to FIG. 16, the French corporation (SEF) which is the second lower level organization may determine priority of confirmed demands of the French corporation (SEF) on the basis of the second lower level rule set by the French corporation (SEF). Like the first lower level rule, the second lower level rule can be set to determine priority of confirmed demands by putting top priority on the week item.

Specifically, referring to FIG. 16 (a), the second lower level rule may be applied only among confirmed demands of the second lower level organization. Referring to FIGS. 16 (b) and (c), priority of confirmed demands of the French corporation (SEF) which is the second lower level organization is changed according to the second lower level rule based on week item. That is, the second level rank determination unit may determine priority of confirmed demands of the French corporation (SEF) by using the second lower level rule such that priority becomes higher as the numerical value of week item becomes smaller.

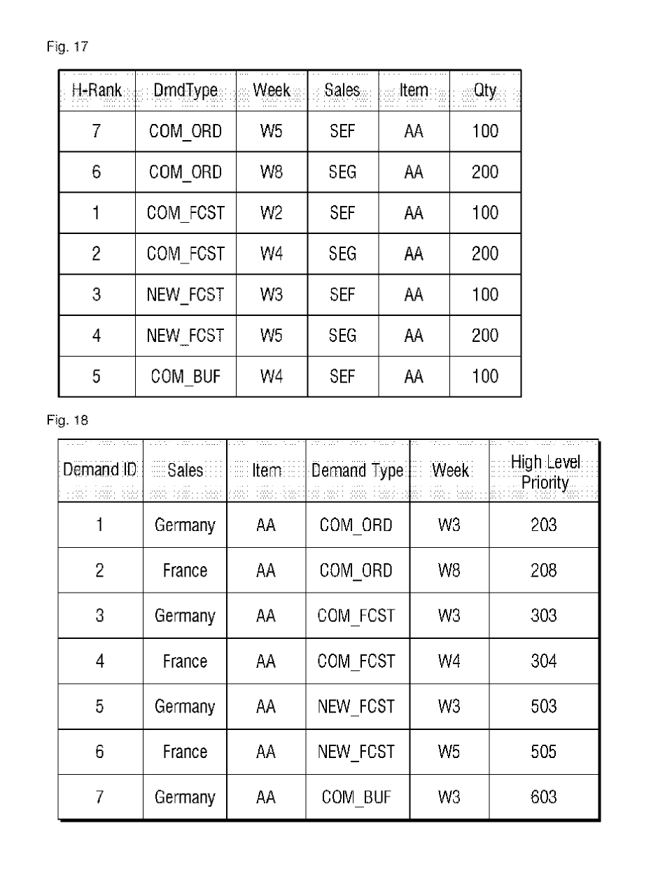

Referring to FIG. 17, the change unit 300 may reflect priority of confirmed demands of the respective lower level organizations determined by the first lower level rank determination unit and the second lower level rank determination unit to comprehensive priorities as described with reference to FIG. 15 and FIG. 16.

Specifically, the change unit 300 may reflect priority of confirmed demands of the respective lower level organizations determined by the respective lower level rank determination units 200 to comprehensive priorities so as to change information of confirmed demands corresponding to the respective priorities of the comprehensive priorities.

The change unit 300 may not change comprehensive priorities of confirmed demands of the respective lower level organizations so as to minimize impact of the priority determined on the basis of the lower level rule of a certain lower level organization on the priority of another lower level organization. However, the change unit 300 changes information of confirmed demands corresponding to the respective priorities of the comprehensive priorities by reflecting priority of confirmed demands of the respective lower level organizations determined by the respective lower level rank determination units 200 to the comprehensive priorities, thereby providing an effects of substantially reallocating the comprehensive priorities.

Specifically, referring to FIG. 15 and FIG. 16, comprehensive priorities H-Rank determined by the preset lower level rule may be fixed and thus not changed, and only the information indicated by each H-Rank is changed according to the priority determined by the first lower level rule and the second lower level rule. That is, a change in the rank according to the priority determined by the first lower level rule has occurred only in the confirmed demands of the first lower level rule, and a change in the rank according to the priority determined by the second lower level rule has occurred only in the confirmed demands of the second lower level rule. The change unit 300 may prevent the priority of confirmed demands of the second lower level organization determined by the preset higher level rule from being affected by the priority determined by the first lower level rule.

The result of change, made by the change unit 300, in the content (order of content) indicated by the comprehensive priorities of confirmed demands determined by the higher level priority determination unit 100 can be used in supply planning, demand control planning and the like.

Another example in which the content corresponding to the comprehensive priorities is changed by the change unit 300 with reference to FIG. 18 to FIG. 20.

The change unit 300 may perform priority swapping. The priority swapping means that the priority of confirmed demands of the respective lower level organizations determined by the preset lower level rule is reflected to the comprehensive rank determined by the preset higher level rule by the change unit 300 so as to thereby change the contents corresponding to the respective comprehensive priorities.

FIG. 18 illustrates an example in which priority is determined by the higher level rank determination unit 100 according to preset higher level rules.

High Level Priority indicates priority values arranged according to the preset higher level rules, and as the High Level Priority has a lower value and as the confirmed demand is located higher in the table of FIG. 18, the priority becomes higher.

Specifically, in FIG. 18, comprehensive priorities values determined by the comprehensive rank value determination unit 140 of the higher level rank determination unit 100 are indicated in the High Level Priority item for each confirmed demand. 203 is a value obtained by arranging 2 which is a rank value indicated by COM_ORD and 03 which is a rank value indicated by W3 according to the arrangement defined in the higher level rules. 304 is a value obtained by arranging 3 which is a rank value indicated by COM_FCST and 04 which is a rank value indicated by W4 according to the arrangement defined in higher level rules.

That is, the preset higher level rule illustrated in FIG. 18 may put higher priority on the Demand Type Rank item which is an item on Demand Type information than on the Week Rank item which is an item on Week information. The setup of the higher level rules may change.

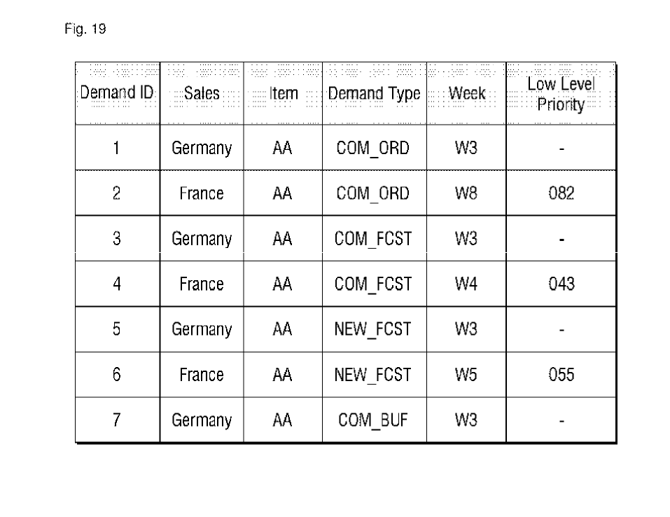

FIG. 19 illustrates an example of a priority value and priority of confirmed demands of the French corporation determined by the lower level rank determination unit 200.

Referring to FIG. 19, it is noted that the lower level rule of the French organization which is a lower level organization puts higher priority on the Week Rank item which is an item of Week information than the Demand Type Rank item which is an item of Demand Type information. Thus, it is noted that when priority values of the respective Demand IDs 2, 4 and 6 corresponding to the French organization are determined by the lower level rank determination units 200 according to the lower level rules, 208 becomes 082, 304 becomes 043, and 505 becomes 055.

In conventional technologies, in case where comprehensive priorities values of the organization to which lower level rules are applied and the organization to which higher level rules are applied mixedly exist, disadvantages may occur in the organization to which higher level rules are applied due to the organization to which lower level rules are applied. That is, it is noted that when the comprehensive priorities values of the respective Demand IDs 2, 4 and 6 determined as illustrated in FIG. 19 are applied to FIG. 18 in which the comprehensive priorities values determined by higher level rules are illustrated, all of the Demand IDs 2, 4 and 6 are put with higher priorities than Demand IDs 1, 3, 5 and 7, which are confirmed demands of the German marketing region.

To solve these problems, the change unit 300 may perform priority swapping. That is, the change unit 300 may maintain the priority determined by the higher level rank determination unit 100 according to the preset higher level rules. When a change occurs in the priority value by the lower level rules, the change unit 300 may change information by applying the changed rank only among confirmed demands to which the corresponding lower level rules are applied among the comprehensive priorities determined by the higher level rules.

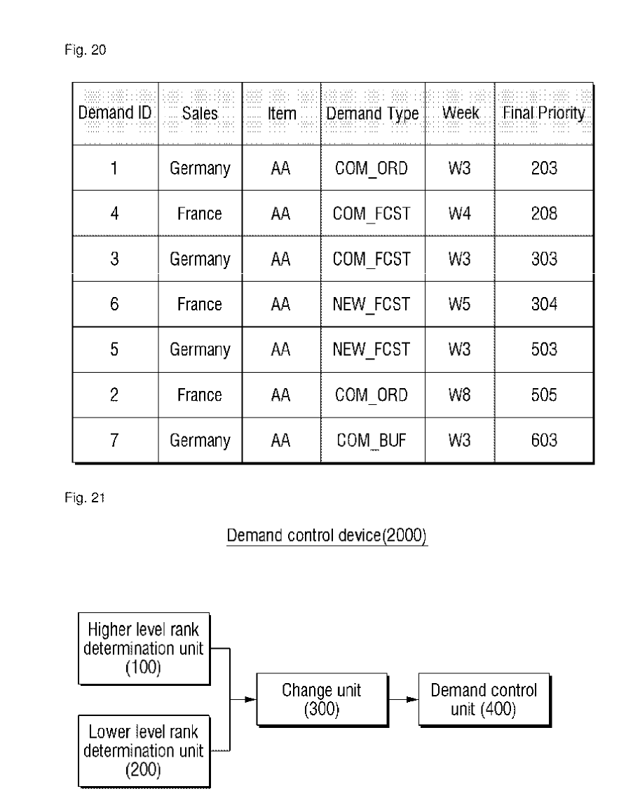

An example of a result of priority swapping performed by the comprehensive priorities determination unit 150 will be described with reference to FIG. 20.

FIG. 20 illustrates an example of a result of reflecting the content of FIG. 19 to FIG. 18 by the change unit.

The change unit 300 may not reflect the priority value illustrated in FIG. 19 as it is to FIG. 18, but may change an order among the Demand IDs 2, 4 and 6 of the French organization to which lower level rules are applied, by applying the priority value generated by the lower level rules illustrated in FIG. 19, while maintaining the comprehensive priorities value and priority determined by the higher level rules.

That is, still referring to FIG. 20, information is changed by reflecting Demand ID 4 being the top priority, Demand ID 6 being the next priority, and Demand ID 2 being the lowest priority in the French organization, thus changing the final ranks in order of Demand IDs 1, 4, 3, 6, 5, 2 and 7.

The change unit 300 may perform priority swapping so as to reflect priority determined by preset lower level rules reflecting urgency of characteristic marketing of a corresponding organization while minimizing disadvantages to other organizations.

FIG. 21 is a block diagram of a demand control device 2000 according to an embodiment of the present inventive concept.

Referring to FIG. 21, the demand control device 2000 according to an embodiment of the present inventive concept may include the higher level rank determination unit 100, the lower level rank determination unit 200, the change unit 300, and a demand control unit 400.

That is, the demand control device 2000 according to an embodiment of the present inventive concept may establish a supply plan and control demands on the basis of the priority of confirmed demands determined by the demand priority determination device 1000. The higher level rank determination unit 100, the lower level rank determination unit 200, and the change unit 300 have been described above, and thus descriptions thereof will be omitted.

The demand control unit 400 may distribute a preset planned supply quantity in a consecutive order from the highest priority (significant) of confirmed demands.

Furthermore, the demand control unit 400 may distribute the preset planned supply quantity in a consecutive order from highest priority of confirmed demands when the preset article quantity is smaller than the total quantity of confirmed demands input by each marketing organization, and process, as a short quantity, the confirmed demands of lower priority to which the planned supply quantity is not distributed so as to prevent supply planning therefor.

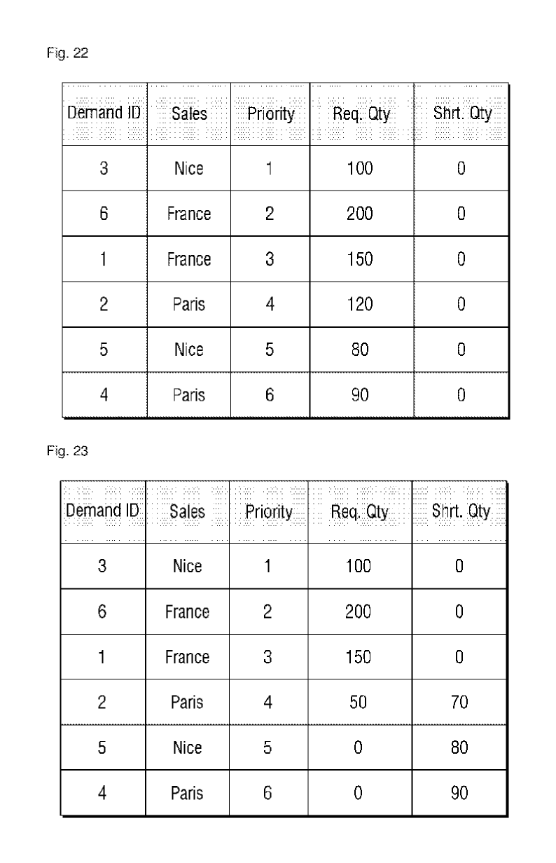

Specifically, referring to FIG. 22, a confirmed demand request quantity (Req. Qty) is illustrated in order of the priority determined by the demand priority determination device 1000 according to an embodiment of the present inventive concept. If an article supply plan to supply 500 articles is established in a company-wide level of an enterprise in consideration of demand control, planned supply quantity or the like, the demand control unit 400 may distribute 500 articles in a consecutive order from the top priority. Referring to FIG. 22, the demand control unit 400 may distribute, from quantity 500, the quantity 100 required by the confirmed demands of Demand ID 3 which is the top priority, and distribute, from the remainder 400, the quantity 200 required by the confirmed demands of Demand ID 6 which is the next priority. Subsequently, the demand control unit 400 may distribute, from the remainder 200, the quantity 150 required by the confirmed demands of Demand ID 1 which is in the third rank. Then, the planned supply quantity remaining after the distribution to the third rank is 50. The demand control unit 400 may distribute the remainder 50 so as to supplement the quantity 120 required by the confirmed demands of Demand ID 2 which is the fourth rank. When the demand control unit 400 distributes the planned supply quantity according to priority, a supply for quantity 70 among 120 required by the confirmed demands of Demand ID 2, quantity 80 required by the confirmed demands of Demand ID 5, and quantity 90 required by the confirmed demands of Demand ID 4 will be short.

The demand control unit 400 may process all of deficient quantity as a short quantity so as to prevent supply planning therefor. FIG. 23 illustrates an example in which a deficient quantity is processed as a short quantity (Shrt. Qty) by the demand control unit 400 under the situation of FIG. 22.

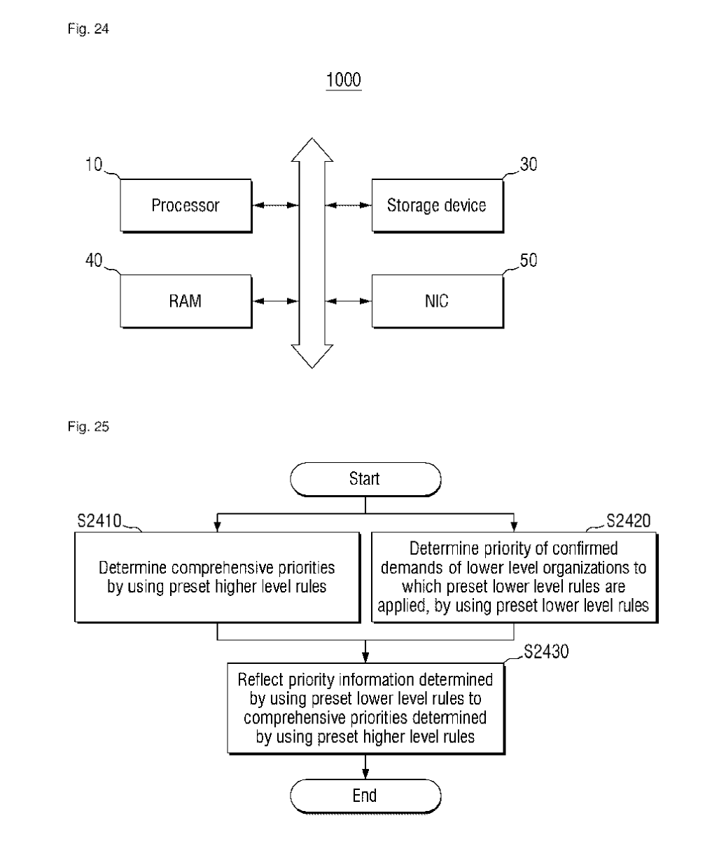

FIG. 24 illustrates a configuration of the demand priority determination device 1000 according to an embodiment of the present inventive concept.

The demand priority determination device 1000 according to an embodiment of the present inventive concept may have a configuration shown in FIG. 24. The demand priority determination device 1000 may include: a processor 10 for executing commands; a storage device 30 for storing therein priority determination program data, data on inputted confirmed demand information, rank value information data corresponding to preset item information and detailed information and the like; a memory 40; and a network interface 50 for data transmission/reception to/from an external device.

The storage device 30 may store there in a program performing: a higher level rank determination process of synthesizing confirmed demands of a first lower level organization and a second lower level organization, and determining comprehensive priorities of the synthesized confirmed demands according to higher level rules set by higher level organizations of the first lower level organization and the second lower level organization; a first lower level rank determination process of determining priority of the confirmed demands of the first lower level organization by using a first lower level rule when the first lower level rule set by the first lower level organization is present; and a changing process of changing information on the confirmed demand corresponding to each priority of the comprehensive priorities by reflecting the priority of the confirmed demands of the first lower level organization determined by the first lower level rank determination step to the comprehensive priorities determined by the higher level rank determination step, and the program can be loaded in a memory and executed through the processor 10. The program stored in the storage device 30 may perform at least one of the processes described with reference to FIG. 1 to FIG. 19.

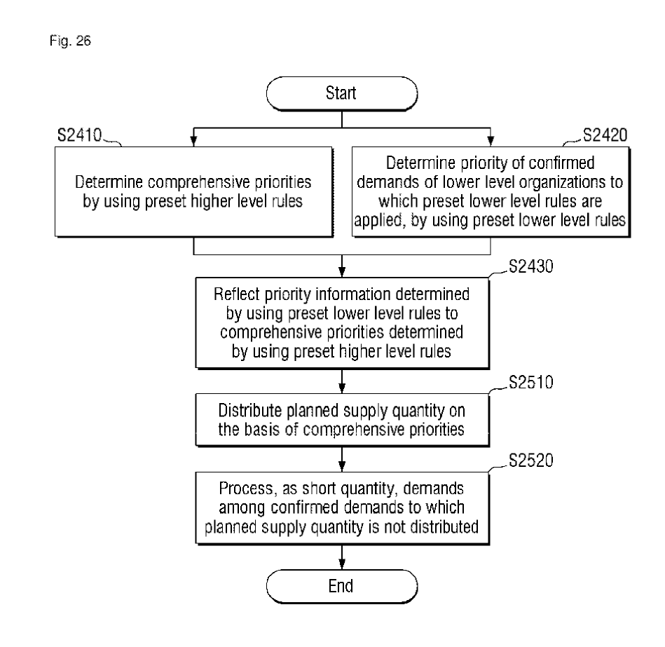

FIG. 25 is a flowchart of a demand priority determination method according to a preferred embodiment of the present inventive concept.

Referring to FIG. 25, the demand priority determination method according to a preferred embodiment of the present inventive concept may enable the higher level rank determination unit 100 to determine comprehensive priorities of confirmed demands of lower level organizations by using preset higher level rules (step S2410).

The lower level rank determination unit 200 may determine priority of confirmed demands of lower level organizations to which respective preset lower level rules are applied, by using one or more preset lower level rules (step S2420).

The change unit 300 may change information corresponding to priority of confirmed demands determined by the higher level rank determination unit 100, by using priority information on confirmed demands of the respective lower level organizations determined by the lower level rank determination unit 200 (step S2430).

FIG. 26 is a flowchart of a demand control method according to an embodiment of the present inventive concept.

Referring to FIG. 26, the demand control method according to an embodiment of the present inventive concept may enable the demand control unit 400 to distribute a planned supply quantity on the basis of the comprehensive priorities changed and determined by the steps S2410 to S2430 ((step S2510).

Furthermore, the demand control unit 400 may process, as a short quantity, the demands among confirmed demands to which the planned supply quantity is not distributed so as to prevent supply planning therefor (step S2520)

All of the contents of the demand priority determination device 1000 and the demand control device 2000 according to an embodiment of the present inventive concept described with reference to FIG. 1 to FIG. 24 can be applied to the demand control method described with reference to FIG. 26.

The components shown in FIG. 5, FIG. 10 and FIG. 20 may mean software or hardware such as a field-programmable gate array or an application-specific integrated circuit (ASIC). However, the components are not limited to software or hardware, and can be constructed to be existed in an addressable storage medium, or to execute one or more processors. The functions provided in the components can be implemented by further subdivided components, and can be implemented into one component in which a plurality of components are synthesized to perform a certain function.

While the exemplary embodiments of the present inventive concept has been described with reference to the attached drawings, it will be understood by those of ordinary skill in the art that the present inventive concept can be embodied in other specific forms without changing technical idea or essential features thereof. It is therefore desired that the present embodiments described above be considered in all respects as illustrative and not restrictive.

What is claimed is:

1. A demand priority determination device comprising:
a higher level rank determination unit which determines comprehensive priorities of confirmed demands of lower level organizations according to higher level rules set by higher lever organizations among organizations having a presence of hierarchical relationships; and
a lower level rank determination unit which determines, according to lower level rules set by at least any one of the lower level organizations, priority of the confirmed demands of a part of the lower level organizations or priority of the confirmed demands of the lower level organization which has set the lower level rules.

2. The demand priority determination device of claim 1, wherein the higher level organizations include, as lower level organizations, a first lower level organization and a second lower level organization, and the lower level rank determination unit determines, when a first lower level rule set by the first lower level organization is present, priority of confirmed demands of the first lower level organization by using the first lower level rule; and
the demand priority determination device further comprises a change unit which changes comprehensive priority information by using priority of confirmed demands of the first lower level organization determined by the lower level rank determination unit.

3. The demand priority determination device of claim 2, wherein the change unit reflects priority of the confirmed demands of the first lower level organization determined by the lower level rank determination unit only among priorities of the confirmed demands of the first lower level organization among the comprehensive priorities determined by the higher level rank determination unit.

4. The demand priority determination device of claim 2, wherein the change unit changes confirmed demand information corresponding to each of the comprehensive priorities by the priority determined by the lower level rank determination unit, but does not change priority of confirmed demands of the second lower level organization among the comprehensive priorities by the priority of the confirmed demands of the first lower level organization determined by the lower level rank determination unit.

5. The demand priority determination device of claim 1, wherein the higher level organizations further include a third lower level organization as the lower level organizations, and a first rank determination unit synthesizes confirmed demands of the first lower level organization, the second lower level organization and the third lower level organization, and determines comprehensive priorities of the synthesized confirmed demands according to the higher level rules set by the higher level organizations.

6. The demand priority determination device of claim 2, wherein the lower level rank determination unit determines, when a second lower level rule set by the second lower level organization is present, priority of the confirmed demands of the second lower level organization by using the second lower level rule, and the change unit changes the confirmed demand information corresponding to each priority of the comprehensive priorities by reflecting the priority of the confirmed demands of the second lower level organization determined by the lower level rank determination unit to the comprehensive priorities determined by the higher level rank determination unit.

7. The demand priority determination device of claim 6, wherein the change unit changes confirmed demand information corresponding to each of the comprehensive priorities by the priority determined by the lower level rank determination unit, but does not change priority of confirmed demands of the first lower level organization among the comprehensive priorities by the priority of the confirmed demands of the second lower level organization determined by the lower level rank determination unit.

8. The demand priority determination device of claim 1, wherein the confirmed demands of the respective organizations are segmented into items regarding two or more demand types.

9. A demand control device comprising:
a higher level rank determination unit which enables a higher level organization of a first lower level organization and a second lower level organization to synthesize confirmed demands of the first lower level organization and the second lower level organization, and determines comprehensive priorities of the synthesized confirmed demands according to higher level rules set by the higher level organization;
a first lower level rank determination unit which determines, when a first lower level rule set by the first lower level organization and different from the higher level rules is present, priority of the confirmed demands of the first lower level organization by using the first lower level rule;
a change unit which changes a content corresponding to each priority of the comprehensive priorities by reflecting the priority of the confirmed demands of the first lower level organization determined by the first lower level rank determination unit to the comprehensive priorities determined by the higher level rank determination unit; and
a demand control unit which distributes a preset planned supply quantity on a basis of the comprehensive priorities of which content is changed by the change unit.

10. The demand control device of claim 9, wherein the demand control unit distributes the preset planned supply quantity in a consecutive order from a rank highest in the comprehensive priorities when the preset planned supply quantity is smaller than a total quantity of confirmed demands input by the organizations.

11. The demand control device of claim 9, wherein the preset planned supply quantity is distributed in a consecutive order from a rank highest in the comprehensive priorities such that confirmed demands to which the planned supply quantity is not distributed are processed as a short quantity.

12. A demand priority determination method comprising:
a higher level rank determination step of determining comprehensive priorities of confirmed demands of lower level organizations according to higher level rules set by higher lever organizations among organizations having a presence of hierarchical relationships; and
a lower level rank determination step of determining, according to lower level rules set by at least any one of the lower level organizations, priority of the confirmed demands of a part of the lower level organizations or priority of the confirmed demands of the lower level organization which has set the lower level rules.

13. The demand priority determination method of claim 12, wherein the higher level organizations include, as lower level organizations, a first lower level organization and a second lower level organization, and the lower level rank determination step determines, when a first lower level rule set by the first lower level organization is present, priority of confirmed demands of the first lower level organization by using the first lower level rule; and
the demand priority determination method changes the comprehensive priority information by using priority of confirmed demands of the first lower level organization determined by the lower level rank determination step.

14. The demand priority determination method of claim 13, wherein the changing step reflects priority of the confirmed demands of the first lower level organization determined by the lower level rank determination step only among priorities of the confirmed demands of the first lower level organization among the comprehensive priorities determined by the higher level rank determination step.

15. The demand priority determination method of claim 13, wherein the changing step changes confirmed demand information corresponding to each of the comprehensive priorities by the priority determined by the lower level rank determination step, but does not change priority of confirmed demands of the second lower level organization among the comprehensive priorities by the priority of the confirmed demands of the first lower level organization determined by the lower level rank determination step.

16. The demand priority determination method of claim 13, wherein the higher level organizations further include a third lower level organization as the lower level organizations, and a first rank determination step synthesizes confirmed demands of the first lower level organization, the second lower level organization and the third lower level organization, and determines comprehensive priorities of the synthesized confirmed demands according to the higher level rules set by the higher level organizations.

17. The demand priority determination method of claim 13, wherein the lower level rank determination step determines, when a second lower level rule set by the second lower level organization is present, priority of the confirmed demands of the second lower level organization by using the second lower level rule, and the changing step changes the confirmed demand information corresponding to each priority of the comprehensive priorities by reflecting the priority of the confirmed demands of the second lower level organization determined by the lower level rank determination step to the comprehensive priorities determined by the higher level rank determination step.

18. The demand priority determination method of claim 17, wherein the changing step changes the confirmed demand information by reflecting priority of the confirmed demands of the second lower level organization determined by the lower level rank determination step only among priorities of the confirmed demands of the second lower level organization among the comprehensive priorities determined by the higher level rank determination step.

19. The demand priority determination method of claim 12, wherein the confirmed demands of the respective organizations are segmented into items regarding two or more demand types.

20. A demand control method comprising:
a higher level rank determination step of enabling a higher level organization of a first lower level organization and a second lower level organization to synthesize confirmed demands of the first lower level organization and the second lower level organization, and determining comprehensive priorities of the synthesized confirmed demands according to higher level rules set by the higher level organization;
a first lower level rank determination step of determining, when a first lower level rule set by the first lower level organization and different from the higher level rules is present, priority of the confirmed demands of the first lower level organization by using the first lower level rule;
a changing step of changing a content corresponding to each priority of the comprehensive priorities by reflecting the priority of the confirmed demands of the first lower level organization determined by the first lower level rank determination step to the comprehensive priorities determined by the higher level rank determination step; and
a demand control step of distributing a preset planned supply quantity on a basis of the comprehensive priorities of which content is changed by the changing step.

21. The demand control method of claim 20, wherein the demand control step distributes the preset planned supply quantity in a consecutive order from a rank highest in the comprehensive priorities when the preset planned supply quantity is smaller than a total quantity of confirmed demands input by the organizations, and processes, as a short quantity, confirmed demands to which the planned supply quantity is not distributed.

22. A computer-readable recording medium having a program recorded thereon, the program performing:
a process of determining comprehensive priorities of confirmed demands of lower level organizations according to higher level rules set by higher lever organizations among organizations having a presence of hierarchical relationships between the higher level organizations and the lower level organizations; and
a process of determining, according to lower level rules set by at least any one of the lower level organizations, priority of the confirmed demands of a part of the lower level organizations or priority of the confirmed demands of the lower level organization which has set the lower level rules.
